(19) United States
(12) Patent Application Publication
(10) Pub. No.: US 2015/0360135 A1
(43) Pub. Date: Dec. 17, 2015

(54) HELICOPTER RETENTION PLATE HARDWARE STAND

(71) Applicant: Stephen George MOSCICKI, SR., Lyman, NH (US)

(72) Inventor: Stephen George MOSCICKI, SR., Lyman, NH (US)

(21) Appl. No.: 14/721,147

(22) Filed: May 26, 2015

Related U.S. Application Data
(60) Provisional application No. 62/010,748, filed on Jun. 11, 2014.

(51) Int. Cl. A63H 27/00; B25H 1/04

(52) U.S. Cl. CPC A63H 27/001; B25H 1/04

(57) ABSTRACT

A standardized hardware stand for organizing the components and subcomponents of helicopter retention plates is provided. The hardware stand could be adapted to be distributed to all air stations so that a repeatable, teachable skill set can be developed, minimizing costly vibratory analysis, problematic clamp-up procedures, and other unnecessary additional maintenance during re-installation of the helicopter retention plates. The hardware stand includes a mock plate forming a plurality of mimicking holes and identifying marks, each dimensioned and adapted to match that of each retention plate maintained, and wherein the mock plate is perpendicularly and rotatably joined to an attachments stem.

### CROSS-REFERENCE TO RELATED APPLICATION

This application claims the benefit of priority of U.S. provisional application No. 62/010,748, filed 11 Jun. 2014, the contents of which are herein incorporated by reference.

### BACKGROUND OF THE INVENTION

The present invention relates to helicopter repair and maintenance and, more particularly, to a hardware stand that facilitates the proper maintenance of a helicopter rotor blade.

When helicopter tail rotor blades become misaligned or mismatched, a vibration is transmitted to the remainder of the helicopter. Because vibrations from misaligned or mismatched tail rotor blade components are significant contributors to airframe fatigue and dynamic component wear, it is critical that the rotor blade components be properly aligned and matched to predetermined engineering values when the rotor blades components are reassembled after being disassembled for maintenance, repair, cleaning, measuring, inspection or the like.

Such critical rotor blade components include Inboard/Outboard (IB/OB) retention plates. Accordingly, a clamp-up procedure of the IB/OB retention plates is required each time one or both of the retention plates are changed. Specifically, after final assembly, bolt protrusion measurements are taken and must fall within limits according to the predetermined engineering values. This is accomplished by adjusting the hardware stack-up for each particular bolt in its respective position. As a result, when retention plate hardware is removed for maintenance, it must be re-installed in the same location to allow bolt protrusion measurements to remain within the predetermined engineering values otherwise a vibratory analysis, an expensive and time consuming procedure, would be required.

Current solutions to organizing retention plate hardware during maintenance include makeshift devices locally manufactured from scrap material, resulting in design flaws that result in lost or damages hardware, expensive vibratory analysis, problematic clamp-up procedures, and other unnecessary additional maintenance. Moreover, current solutions frustrate the opportunity to develop an inculcated skill set necessary to properly use such devices, a skill set which could be universally taught and standardized at air stations around the globe.

As can be seen, there is a need for a standardized hardware stand for organizing the components and subcomponents of helicopter retention plates, whereby the hardware stand could be distributed to all air stations so that a repeatable, teachable skill set can be developed, minimizing costly vibratory analysis, problematic clamp-up procedures, and other unnecessary additional maintenance.

### SUMMARY OF THE INVENTION

In one aspect of the present invention, a hardware stand for facilitating the maintenance of helicopter tail blade retention plates includes an attachment stem; a mock plate perpendicularly connected to the attachment stem; and a plurality of mimicking holes formed in the mock plate, wherein the plurality of mimicking holes are dimensioned and adapted to match that of each retention plate maintained.

In another aspect of the present invention, a hardware stand for facilitating the maintenance of helicopter tail blade retention plates includes an attachment stem having knurling along a portion thereof; a plus-shaped mock plate perpendicularly and rotatably connected to the attachment stem; a plurality of mimicking holes formed in the mock plate, wherein the plurality of mimicking holes are dimensioned and adapted to match that of each retention plate maintained; a plurality of identifying marks along an upwardly facing surface of the mock plate, wherein the plurality of identifying marks are color coordinated to match that of each retention plate maintained; a base perpendicularly and rotatably connected to the attachment stem, on an opposing end as the mock plate; and a supporting surface along a portion of the base.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention;

FIG. 2 is a bottom perspective view of an exemplary embodiment of the present invention;

FIG. 3 is a top plan view of an exemplary embodiment of the present invention; and

FIG. 4 is a cross-sectional view of an exemplary embodiment of the present invention, taken along line 4-4 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a standardized hardware stand for organizing the components and subcomponents of helicopter retention plates, whereby the hardware stand could be distributed to all air stations so that a repeatable, teachable skill set can be developed, minimizing costly vibratory analysis, problematic clamp-up procedures, and other unnecessary additional maintenance. The hardware stand includes a mock plate forming a plurality of mimicking holes and identifying marks, each dimensioned and adapted to match that of each retention plate maintained, and wherein the mock plate is perpendicularly and rotatably joined to an attachments stem.

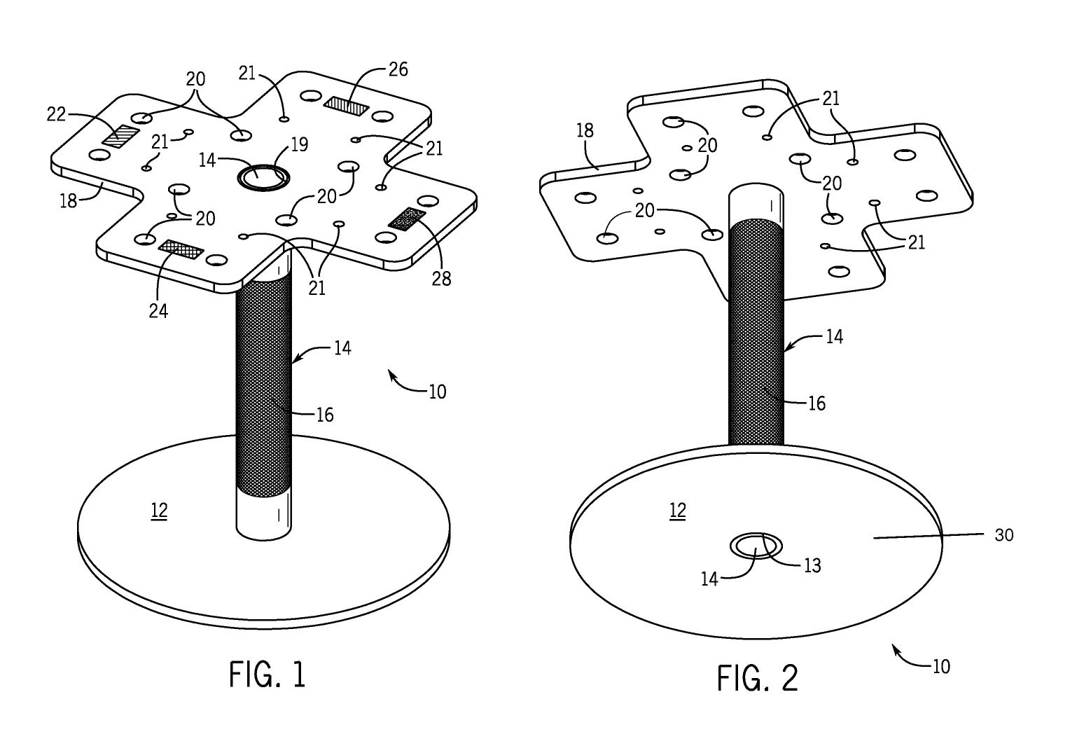

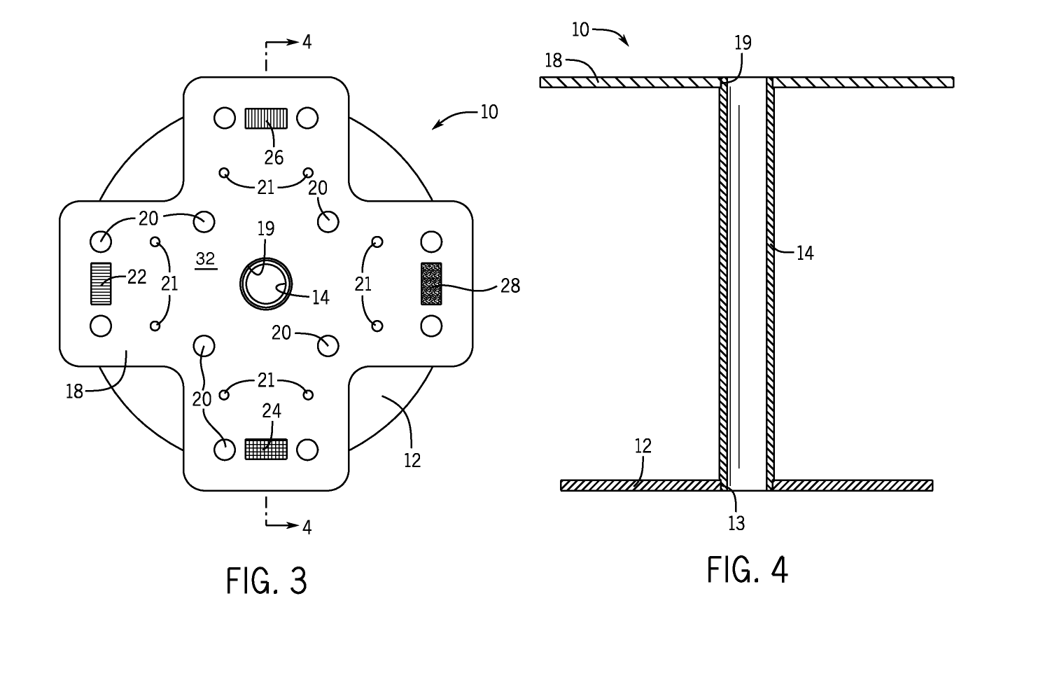

Referring to FIGS. 1 through 4, the present invention may include a hardware stand 10. The hardware stand 10 may include an attachment stem 18 interconnecting a base 12 and a mock plate 18. The base 12, the attachment stem 14 and the mock plate 18 may be made of metal that can be molded or stamped to the shape and dimensions required to have the function described herein, as known to those skilled in the relevant art. Knurling 16 may be disposed along a portion of the length of the attachment stem 14 to facilitate an operable grip thereof.

The base 12 may for an attachment hole 13 dimensioned and adapted to secure the attachment stem 14. The mock plate 18 may form an attachment bore 19 dimensioned and adapted to secure the opposing end of the attachment stem 14. In certain embodiments, the attachment stem 14 may be rotatably connected to the mock plate 18 and/or the base 12 so that the mock plate 18 and/or the attachment stem 14 may be rotated relative to the attachment stem 14 and/or the base 12. The attachment stem 14 may be placed centrally about the base 12 and the mock plate 18 so as to maximize the operable balance of the hardware stand 10.

The hardware stand 10 may be used to aid in the maintenance of at least one helicopter component. The helicopter component may include, but not necessarily be limited to an IB/OB retention plate. The helicopter component may include a plurality of related hardware or subcomponents that needs to be inspected, replaced, modified, or the like, and then placed back on the helicopter component pursuant to predetermined engineering values when reinstalling the hardware component back to the helicopter. The subcomponents include, but are not limited to bolts, washers, nut stack-ups and the like

The base 12 may include a supporting surface 30 adapted to secure the hardware stand 10 in an operable position with the mock plate 18 upward facing. The base 12 may include grip tape or other adhesive means on the supporting surface 30 in order to secure the support surface 30 to a work station or the like. In certain embodiments, the mock plate 18 may be ‘Plus’-shaped.

The mock plate 18 may define a plurality of mimicking holes 20, 21. The dimensions, arrangement and disposition of the plurality of mimicking holes 20, 21 may be adapted to generally align and/or replicate the dimensions, arrangement and disposition of corresponding holes of the helicopter component to be maintained. The mock plate 18 may include a plurality of outwardly facing identifying markings 22, 24, 26, 28 along an upwardly facing surface 32. Each identifying marking may be adapted to mimic a similar markings found on the helicopter component and/or its origin helicopter. The plurality of identifying markings 22, 24, 26, 28 may include identifying and corresponding shapes, colors and the like. The plurality of mimicking holes 20, 21 and the plurality of identifying markings 22, 24, 26, 28 are configured so that an operator may remove one subcomponent at a time and keep it organized on the hardware stand 10 for subsequent re-installation of the helicopter component onto the helicopter during post-maintenance reassembly. Because the hardware stand 10 is similarly marked and shaped as the helicopter and its components, it facilitates a user to remove one piece of component or subcomponent at a time from the helicopter to the hardware stand 10.

The method of using the present invention may include the following. The hardware stand 10 disclosed above may be provided. The operator may attach the support surface 30 to their workstation so that the mock plate 18 is disposed in the operable position. Then the operator may remove each subcomponent, for example, bolt, washer, nut stack-up and the like, of the helicopter component when disassembling it from the helicopter so as to remove the helicopter component. Then the operator may sequentially align each subcomponent with each of the plurality of mimicking hole 20, 21 that mimics the corresponding hole found on the helicopter and/or helicopter component, whereby the operator is in essence temporarily re-assembling the helicopter component on the hardware stand 10. Then the operator may match any identifying markings on each subcomponent to the plurality of identifying markings 22, 24, 26, 28 so that each subcomponent is organized and configured to align with the corresponding mimicking hole 20, 21 and corresponding helicopter identifying markings, thereby organizing the helicopter component and any subcomponents for efficient re-installation to the helicopter.

In certain embodiments, the method of making the hardware stand 10 may include the following. The mock plate 18 may be cut with a CNC plasma cutter into two different shapes: a 9″ diameter circle with a 1.25″ diameter hole, and a 10″×10″ “plus sign” shape with a 1.25″ diameter center hole. The attachment stem 14 may be cut to a length of 10″. All parts 12, 14, 18 may be initially sanded, filed, and deburred and left with smooth surfaces and chamfered edges. The mimicking bolt 20, 21 pattern may be then laid out on the mock plate 20, 21, then the mimicking holes 20, 21 are drilled where the center hole may be machined to 1.300″. The base 12 center hole may also be machined to 1.300. The first 0.25″ of either end of the mock plate 18 may be turned to 1.300, and then the first 0.100″ is chamfered to a 45 degree angle. The center 7.5″ of the attachment stem 14 may be diamond knurled. The attachment stem 14 may then inserted into the round piece and welded on the outside edge. The protruding weld bead may then be machined flat and the OD of the base 12 may be turned to a machined finish. The other end of the attachment stem 14 may then be inserted into the mock plate 18 and welded on the outside edge. The completed hardware stand 10 may then be cleaned and deburred, then marked with 1″×0.500″ identifying markings 22, 24, 26, 28 by use of blue, red, yellow, and black paint.

It should be understood, of course, that the foregoing relates to exemplary embodiments of the invention and that modifications may be made without departing from the spirit and scope of the invention as set forth in the following claims.

What is claimed is:

1. A hardware stand for facilitating the maintenance of helicopter tail blade retention plates, comprising:
an attachment stem;
a mock plate perpendicularly connected to the attachment stem; and
a plurality of mimicking holes formed in the mock plate, wherein the plurality of mimicking holes are dimensioned and adapted to match that of each retention plate maintained.

2. The hardware stand of claim 1, wherein the mock plate is plus-shaped.

3. The hardware stand of claim 1, further comprising a plurality of identifying marks along an upwardly facing surface of the mock plate.

4. The hardware stand of claim 3, wherein the plurality of identifying marks are color coordinated to match that of each retention plate maintained.

5. The hardware stand of claim 1, wherein the attachment stem is rotatably connected to the mock plate.

6. The hardware stand of claim 1, further comprising a base perpendicularly connected to the attachment stem, on an opposing end as the mock plate.

7. The hardware stand of claim 6, wherein the base is rotatably connected to the mock plate.

8. The hardware stand of claim 6, further comprising a supporting surface along a portion of the base.

9. The hardware stand of claim 6, further comprising knurling along a portion of a length of the attachment stem.

10. A hardware stand for facilitating the maintenance of helicopter tail blade retention plates, comprising:
an attachment stem having knurling along a portion thereof;
a plus-shaped mock plate perpendicularly and rotatably connected to the attachment stem;
a plurality of mimicking holes formed in the mock plate, wherein the plurality of mimicking holes are dimensioned and adapted to match that of each retention plate maintained;
a plurality of identifying marks along an upwardly facing surface of the mock plate, wherein the plurality of identifying marks are color coordinated to match that of each retention plate maintained;
a base perpendicularly and rotatably connected to the attachment stem, on an opposing end as the mock plate; and
a supporting surface along a portion of the base.
